(19) United States
(12) Patent Application Publication
(10) Pub. No.: US 2014/0368148 A1
(43) Pub. Date: Dec. 18, 2014

(54) MOTOR LOCK DETECTING CIRCUIT AND CONTROL METHOD THEREOF

(71) Applicant: Sharp Kabushiki Kaisha, Osaka (JP)

(72) Inventor: Hiroki Kai, Osaka (JP)

(73) Assignee: SHARP KABUSHIKI KAISHA, Osaka (JP)

(21) Appl. No.: 14/375,851

(22) PCT Filed: Jan. 25, 2013
(86) PCT No.: PCT/JP2013/051569

§ 371 Date: Jul. 31, 2014

(30) Foreign Application Priority Data
Feb. 1, 2012 (JP) 2012-019672

(51) Int. Cl. H02P 29/02

(52) U.S. Cl. CPC H02P 29/021
USPC 318/490

(57) ABSTRACT

A lock detecting circuit includes: a CPU 204; switches 220 to 224 controlled by control signals FAN1 to FANn output from the CPU and supplying electric power to motors 210 to 214; gates 240 to 244 controlled by the control signals and selectively outputting, as signals XLD1 to XLDn, input motor state signals LD1 to LDn; and an element 232 outputting, as a signal LOCK, a result of logical sum of the signals XLD1 to XLDn. If the signal LOCK indicates a locked state, the CPU sets any one of the control signals to a high level and, in this state, determines the level of signal LOCK, to determine whether each motor is locked. Thus, a locked motor can be identified.

### TECHNICAL FIELD

The present invention relates to a lock detecting circuit for identifying, when one CPU drives a plurality of motors, a motor of which rotation is abnormally stopped (locked), as well as to a control method thereof.

### BACKGROUND ART

As one type of image processing apparatuses as electronic equipment, an image forming apparatus (typically a copy machine) for forming an image on a sheet of recording paper has been introduced to many places of business (companies and offices). An MFP (MultiFunction Peripheral) as one type of such image forming apparatuses has a plurality of functions including a copy function, a facsimile (hereinafter facsimile will be also denoted as FAX) function, a network compatible printer function and a scanner function.

When the image forming apparatus executes various functions, heat generates in the image forming apparatus. By way of example, the image forming apparatus is provided with a heater for heating toner and fixing on a sheet of recording paper, when it realizes the copy function, the print function and the facsimile receiving function and hence, when an image is formed, the temperature inside the image forming apparatus becomes high. Further, an image reading unit (scanner) is provided with a laser light emitting device, which is also a heat source. Therefore, the image forming apparatus includes a plurality of fans to cool the inside of image forming apparatus. If a motor driving a fan (hereinafter referred to as a fan motor) fails and the rotation of motor is stopped (locked) while electric power is fed to the motor, cooling of the inside of image forming apparatus can be insufficient, possibly damaging the apparatus. If the fan motor itself is normal and some foreign matter stops the rotation of the fan (and the rotation of the fan motor), the fan motor can be overloaded and overheated, possibly causing fire. Therefore, lock of a fan motor must immediately be detected.

By way of example, Japanese Patent Laying-Open No. 63-174517 discloses a motor lock detecting circuit. The lock detecting circuit detects an excess current flowing through a motor, and when the excess current exceeds a prescribed value (threshold level), it outputs a motor lock signal.

Further, it is common to use a CPU having only a small number of input/output ports in an image forming apparatus. It is desirable to have such a CPU to control a plurality of fan motors and to detect any lock. In this regard, Japanese Patent Laying-Open No. 64-50795 discloses a circuit with one CPU in which states of a plurality of dip switches are read using a plurality of output ports and an input port, by switching excitation phases of a stepping motor, without using an external extension board.

FIG. 1 shows one known example of a circuit for controlling on/off of a plurality of fan motors and for detecting malfunction of these motors using one input port, using one CPU. Referring to FIG. 1, CPU 100 outputs first and second control signals FAN1 and FAN2, for controlling on/off of the rotation of first and second fan motors 110 and 112. First and second switches 120 and 122 are, for example, power transistors, and the first and second control signals FAN1 and FAN2 are input to the gates of corresponding power transistors, respectively.

The first control signal FAN1 controls on/off of first switch 120. The first switch 120 is off if the first control signal FAN1 is at a low level, and it is on if the first control signal FAN1 is at a high level. When the first switch 120 is turned on, a voltage supplied from an external power source is applied to the first fan motor 110, and the first fan motor 110 rotates. Similarly, the second control signal FAN2 controls on/off of the second switch 122. The second switch 122 is off if the second control signal FAN2 is at the low level, and it is on if the second control signal FAN2 is at the high level. When the second switch 122 is turned on, a voltage supplied from an external power source is applied to the second fan motor 112, and the second fan motor 112 rotates.

The first and second fan motors 110 and 112 output first and second state signals LD1 and LD2, respectively, indicating the states of rotation of fan motors. The first and second state signals LD1 and LD2 are at the low level as long as the corresponding first and second fan motors 110 and 112 are rotating normally, while the signals attain to the high level when the rotation stops. The first and second state signals LD1 and LD2 are input to a logical sum operation element 130. Logical sum operation element 130 outputs the result of logical summation of the input signals as a lock signal LOCK. The lock signal LOCK is input to CPU 100. First and second pull-up resistors 150 and 152 are provided for preventing input levels to logical sum operation element 130 from becoming unstable.

While the first and second fan motors 110 and 112 rotate normally in accordance with the voltage supply, the first and second state signals LD1 and LD2 are at the low level and the lock signal LOCK is at the low level. If either one of the first and second fan motors 110 and 112 stops rotation (locked) while receiving power supply, that one of the first and second state signals LD1 and LD2 which is output from the locked fan motor attains to the high level. Thus, the lock signal LOCK attains to the high level. Therefore, it is possible for CPU 100 to detect locking of the first and second fan motors 110 and 112, using one input port (input port for the lock signal LOCK).

FIG. 2 shows changes of respective signals when the first control signal FAN1 or the second control signal FAN2 is changed, in the lock detecting circuit shown in FIG. 1. Here, it is assumed that the first and second fan motors 110 and 112 are operating normally. In a first time period T1, the first and second control signals FAN1 and FAN2 are at the high level, and the first and second state signals LD1 and LD2 are at the low level (indicating the rotating state) and, hence, the lock signal LOCK is at the low level. In a second time period T2, the second control signal FAN2 attains to the low level, the second state signal LD2 attains to the high level (rotation stopped), and the lock signal LOCK attains to the high level. In a third time period T3, the first control signal FAN1 attains to the low level, the first state signal LD1 attains to the high level (rotation stopped), and the lock signal is at the high level. In a fourth time period T4, the first and second control signals FAN1 and FAN2 attain to the low level, the first and second state signals LD1 and LD2 attain to the high level (rotation stopped), and the lock signal LOCK is at the high level.

Referring to FIG. 2, if either one of the first and second fan motors 110 and 112 is locked, the lock signal LOCK attains to the high level. By way of example, FIG. 3 shows a state in which the first fan motor is locked (though electric power is supplied, it does not rotate and the first control signal FAN1 is at the high level). Since the first fan motor 110 is locked, the first state signal LD1 is always kept at the high level. Since the lock signal LOCK is at the high level though the first and second control signals FAN1 and FAN2 were set to the high level in the first time period T1, the CPU detects that either the first fan motor 110 or the second fan motor 112 is locked.

### DISCLOSURE OF THE INVENTION

### Problems to be Solved by the Invention

As described above, in the lock detecting circuit shown in FIG. 1, the CPU can detect that either the first fan motor 110 or the second fan motor 112 is locked. It is impossible, however, to identify which fan motor is locked. Specifically, even when the CPU changes the levels of first and second control signals FAN1 and FAN2 in the second to fourth time periods T2 to T4 of FIG. 3, the lock signal LOCK is kept at the high level. When the second fan motor 112 is locked (though electric power is supplied, it does not rotate and the second control signal FAN2 is at the high level), similarly, the lock signal LOCK is kept at the high level, even when the CPU changes the levels of first and second control signals FAN1 and FAN2.

As described above, though the lock detecting circuit shown in FIG. 1 can detect that either one of the first and second fan motors 110 and 112 is locked, by detecting the level of lock signal LOCK, it cannot identify which fan motor is locked.

In an image forming apparatus, fans are arranged not on the front side from which a user operates the apparatus, but on the back or along the sides. Therefore, even when it is detected that any of the fan motors is locked, it would be difficult for the user to check fan rotation visually or by touching, depending on where the image forming apparatus is installed. Further, in an image forming apparatus, motors are used for various purposes other than for the fans and, hence, it is also desirable to immediately identify a locked motor among these motors.

Therefore, an object of the present invention is to provide a lock detecting circuit for identifying, when one CPU drives a plurality of motors, a locked motor, as well as a control method thereof.

### Means for Solving the Problems

The above-described object can be attained by the following.

Specifically, the object can be attained by the lock detecting circuit for detecting lock of a plurality of motors according to the present invention, including: a control unit; a power supply unit, responsive to a control signal corresponding to each of the plurality of motors, output from the control unit, for supplying electric power to the motor corresponding to the control signal; a plurality of gate units respectively corresponding to the plurality of motors, each of which selectively outputting, in accordance with a level of each of the plurality of control signals, a state signal indicating state of rotation of the motor input from the motor corresponding to the control signal; and a logical operation unit receiving gate output signals output from the plurality of gate units, and selectively outputting a signal of one of different levels depending on whether a signal of a first level indicating that rotation of the motor is stopped is included among the gate output signals; wherein if the control signal is a signal of a second level causing the power supply unit to supply electric power to the motor corresponding to the control signal, the gate unit outputs directly or after inversion the state signal input to the gate unit, as the gate output signal; if the control signal is a signal of a third level not causing the power supply unit to supply electric power to the motor corresponding to the control signal, the gate output signal becomes a signal of a fourth level obtained by inverting the first level; and in response to detecting that the output signal from the logical operation unit is a signal of a fifth level output when the gate output signals received by the logical operation unit include the signal of the first level, the control unit changes levels of the plurality of control signals such that the plurality of control signals include the signal of the third level, and thereby identifies a locked motor among the plurality of motors.

Preferably, the first level is a high level, and the logical operation unit is a logical sum operation unit.

More preferably, the first level is a low level, and the logical operation unit is a NAND operation unit.

More preferably, in response to detecting that the output signal from the logical operation unit is the signal of the fifth level, the control unit changes the levels of the plurality of control signals such that one of the plurality of control signals is the signal of the second level and the control signals other than the control signal of the second level are the signals of the third level, and in this state, determines whether or not the output signal from the logical operation unit is the signal of the fifth level.

Preferably, in response to detecting that the output signal from the logical operation unit is the signal of the fifth level, the control unit changes the levels of the plurality of control signals such that one of the plurality of control signals is the signal of the third level and the control signals other than the control signal of the third level are the signals of the second level, and in this state, determines whether or not the output signal from the logical operation unit is the signal of the fifth level.

The present invention provides a method of controlling a lock detecting circuit for a plurality of motors, including: a control unit; a power supply unit, responsive to a control signal corresponding to each of the plurality of motors, output from the control unit, for supplying electric power to the motor corresponding to the control signal; a plurality of gate units respectively corresponding to the plurality of motors, each of which selectively outputting, in accordance with a level of each of the plurality of control signals, a state signal indicating state of rotation of the motor input from the motor corresponding to the control signal; and a logical operation unit receiving gate output signals output from the plurality of gate units, and selectively outputting a signal of one of different levels depending on whether a signal of a first level indicating that rotation of the motor is stopped is included among the gate output signals; wherein if the control unit is a signal of a second level causing the power supply unit to supply electric power to the motor corresponding to the control signal, the gate unit outputs directly or after inversion the state signal input to the gate unit, as the gate output signal; if the control signal is a signal of a third level not causing the power supply unit to supply electric power to the motor corresponding to the control signal, the gate output signal becomes a signal of a fourth level obtained by inverting the first level; the method including: a determining step of causing the control unit to determine whether or not the output signal from the logical operation unit is a signal of a fifth level output when the gate output signals received by the logical operation unit include the signal of the first level; a step of causing, in response to a determination at the determining step that the output signal from the logical operation unit is the signal of the fifth level, the control unit to change levels of the plurality of control signals such that the plurality of control signals include the signal of the third level; and a step of causing, with the levels of the plurality of control signals changed, the control unit to determine whether or not the output signal from the logical operation unit is the signal of the fifth level.

### Effects of the Invention

By the present invention, it becomes possible to detect, when states of operation of a plurality of motors are detected using a signal input to one port (output signal from the logical operation unit) and the plurality of motors are driven by one CPU (control unit), that any of the plurality of motors is locked and, in addition, to identify the locked motor.

Therefore, it becomes possible to stop only the locked motor and to present information related to the locked motor to the user. Thus, security is ensured and it becomes possible to immediately ask a service person for a quick repair.

### BRIEF DESCRIPTION OF THE DRAWINGS

FIG. 1 is a circuit diagram showing a conventional fan motor lock detecting circuit.

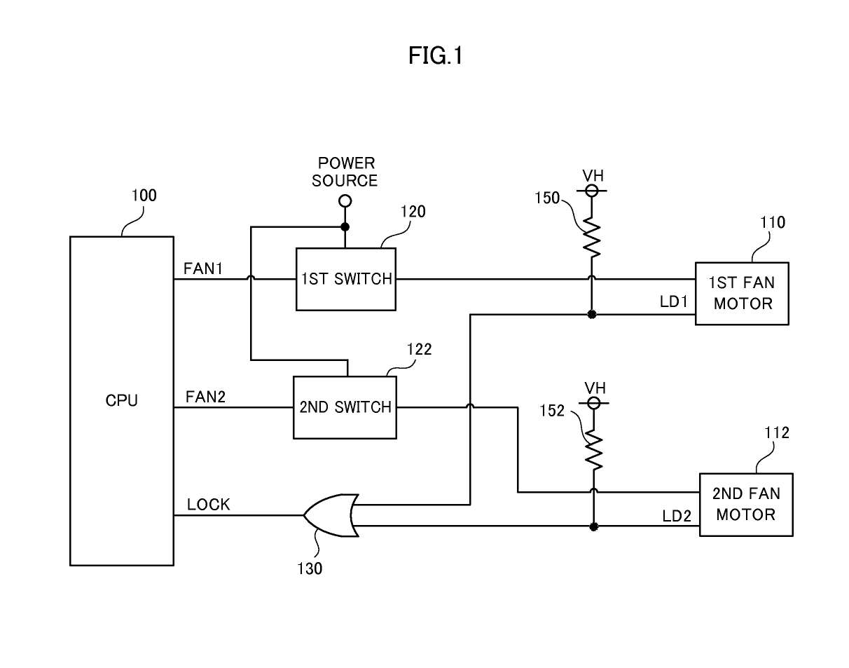

FIG. 2 is a timing chart showing signals in the lock detecting circuit of FIG. 1.

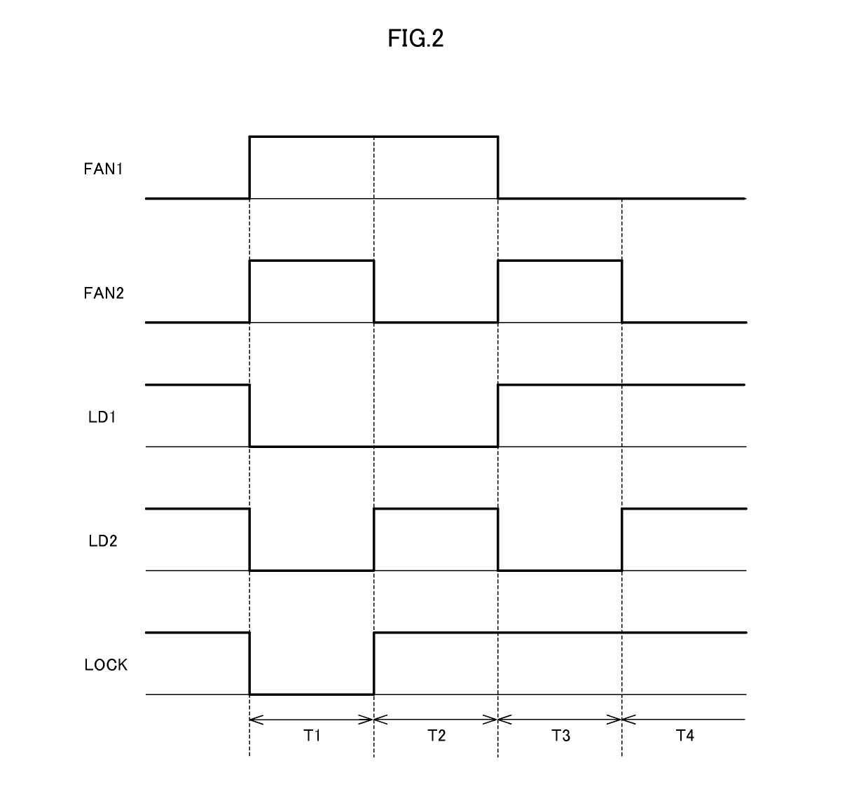

FIG. 3 is a timing chart showing signals in the lock detecting circuit of FIG. 1, when a fan motor is locked.

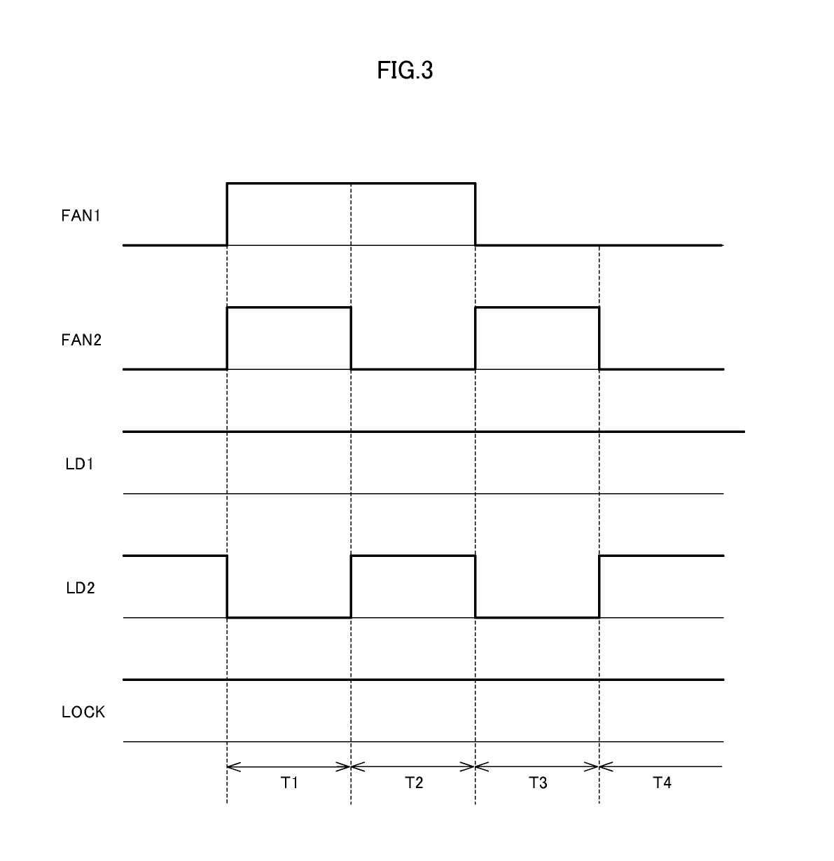

FIG. 4 is a circuit diagram showing a lock detecting circuit for two fan motors in accordance with an embodiment of the present invention.

FIG. 5 is a timing chart showing signals in the lock detecting circuit of FIG. 4, when fan motors are not locked.

FIG. 6 is a flowchart representing a control structure of a lock detecting program executed in the lock detecting circuit of FIG. 4.

FIG. 7 is a timing chart showing signals in the lock detecting circuit of FIG. 4, when the first fan motor is locked.

FIG. 8 is a timing chart showing signals in the lock detecting circuit of FIG. 4, when the second fan motor is locked.

FIG. 9 is a timing chart showing signals in the lock detecting circuit of FIG. 4, when the first and second fan motors are locked.

FIG. 10 is a circuit diagram showing a lock detecting circuit for three or more fan motors in accordance with an embodiment of the present invention.

FIG. 11 is a flowchart representing a control structure of a lock detecting program executed in the lock detecting circuit of FIG. 10.

FIG. 12 is a timing chart showing signals in the lock detecting circuit (n=3) of FIG. 10, when the second fan motor is locked.

FIG. 13 is a timing chart showing signals in the lock detecting circuit (n=3) of FIG. 10, when the second and third fan motors are locked.

FIG. 14 is a circuit diagram showing a lock detecting circuit having gates different from those of the lock detecting circuit shown in FIG. 10.

FIG. 15 is a circuit diagram showing a lock detecting circuit having a logical operation element different from that of the lock detecting circuit shown in FIG. 10.

### DESCRIPTION OF EMBODIMENTS

In the following embodiments, the same components are denoted by the same reference characters. Their names and functions are also the same. Therefore, detailed description thereof will not be repeated.

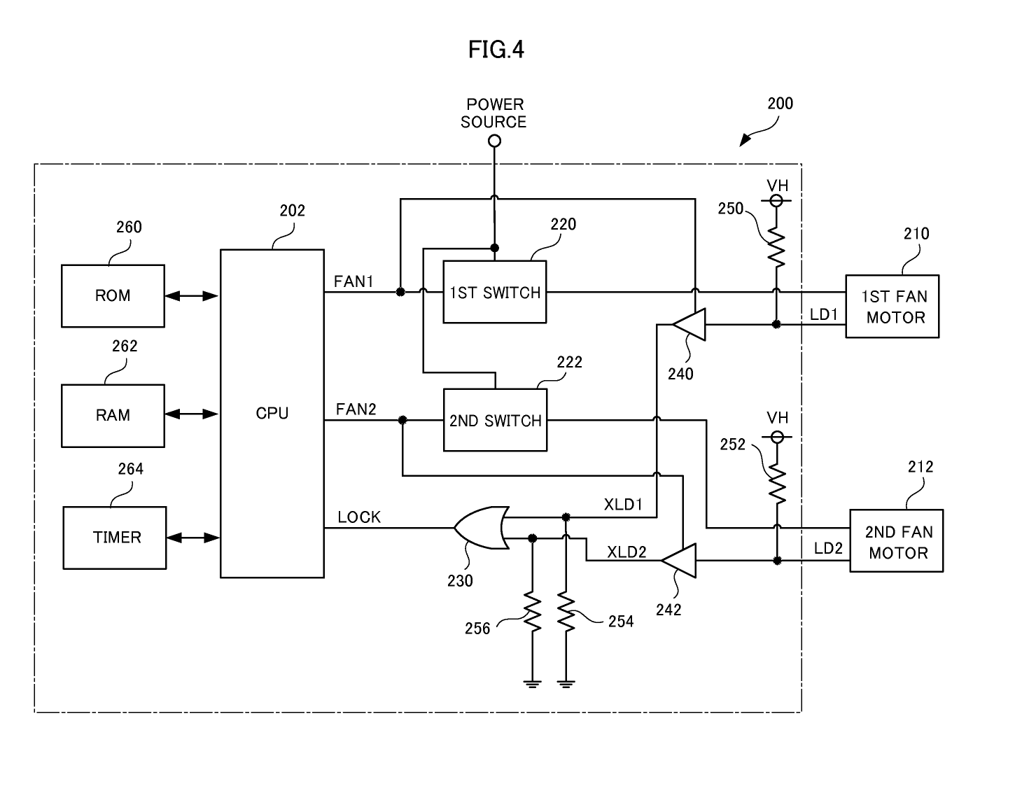

Referring to FIG. 4, a lock detecting circuit 200 in accordance with an embodiment of the present invention includes a CPU 202, a first switch 220, a second switch 222, a logical sum operation element 230, a first gate 240, a second gate 242, a first pull-up resistor 250, a second pull-up resistor 252, a first pull-down resistor 254, a second pull-down resistor 256, an ROM 260, an RAM 262 and a timer 264.

ROM (Read Only Memory) 260 stores a program and data necessary for controlling the operation of lock detecting circuit 200. ROM 260 is non-volatile storage that retains data even when power is turned off. RAM (Random Access Memory) 262 is volatile storage. CPU 202 controls the first and second fan motors 210 and 212 in accordance with the program stored in ROM 260, and realizes the function of detecting abnormality of these fan motors. Specifically, CPU 202 reads the program from ROM 260 to RAM 262, and executes the program using part of RAM 262 as a work area. Timer 264 provides information representing current time (hereinafter simply referred to as current time), to CPU 202, upon request from CPU 202.

CPU 202 outputs first and second control signals FAN1 and FAN2 for controlling on/off of first and second fan motors 210 and 212. First and second switches 220 and 222 are, for example, power transistors, and the first and second control signals FAN1 and FAN2 are input to the gates of corresponding power transistors, respectively. The first control signal FAN1 controls on/off of first switch 220. The first switch 220 is off if the first control signal FAN1 is at a low level, and it is on if the first control signal FAN1 is at a high level. When the first switch 220 is turned on, a voltage supplied from an external power source is applied to the first fan motor 210, and the first fan motor 210 rotates. Similarly, the second control signal FAN2 controls on/off of the second switch 222. The second switch 222 is off if the second control signal FAN2 is at the low level, and it is on if the second control signal FAN2 is at the high level. When the second switch 222 is turned on, a voltage supplied from an external power source is applied to the second fan motor 212, and the second fan motor 212 rotates.

The first and second fan motors 210 and 212 output first and second state signals LD1 and LD2, respectively, indicating the states of rotation of fan motors. The first and second state signals LD1 and LD2 are at the low level as long as the corresponding first and second fan motors 210 and 212 are rotating normally, while the signals attain to the high level when the rotation stops. The first and second state signals LD1 and LD2 are input to first and second gates 240 and 242, respectively.

First and second gates 240 and 242 are, for example, PMOS type FET transistors, functioning as switches. The first gate 240 is turned on when the first control signal FAN1 is at the high level, and outputs the input first state signal LD1 as a first gate output signal XLD1. The first gate 240 is turned off when the first control signal FAN1 is at the low level, and it does not output the input first state signal LD1. Here, the first gate output signal XLD1 is grounded by the first pull-down resistor 254, and attains to the low level. Similarly, the second gate 242 is turned on when the second control signal FAN2 is at the high level, and outputs the input second state signal LD2 as a second gate output signal XLD2. The second gate 242 is turned off when the second control signal FAN2 is at the low level, and it does not output the input second state signal LD2. Here, the second gate output signal XLD2 is grounded by the second pull-down resistor 256, and attains to the low level.

The first and second gate output signals XLD1 and XLD2 are input to logical sum operation element 230. Logical sum operation element 230 outputs the result of logical summation of input signals as lock signal LOCK. Lock signal LOCK is input to CPU 202. The first and second pull-up resistors 250 and 252 are provided for preventing the input levels of first and second gates 240 and 242, respectively, from becoming unstable, and a high level voltage VH is applied thereto.

As long as the first and second fan motors 210 and 212 are rotating normally in accordance with the supplied power, the first and second state signals LD1 and LD2 are at the low level, and the lock signal LOCK is at the low level. If either the first fan motor 210 or the second fan motor 212 stops rotation (locked) though the power is supplied, that one of the first and second state signals LD1 and LD2 which is output from the locked fan motor attains to the high level. Thus, the lock signal LOCK attains to the high level. Therefore, by monitoring the lock signal LOCK, CPU 202 can detect lock of the first and second fan motors 210 and 212. Specific description will be given below.

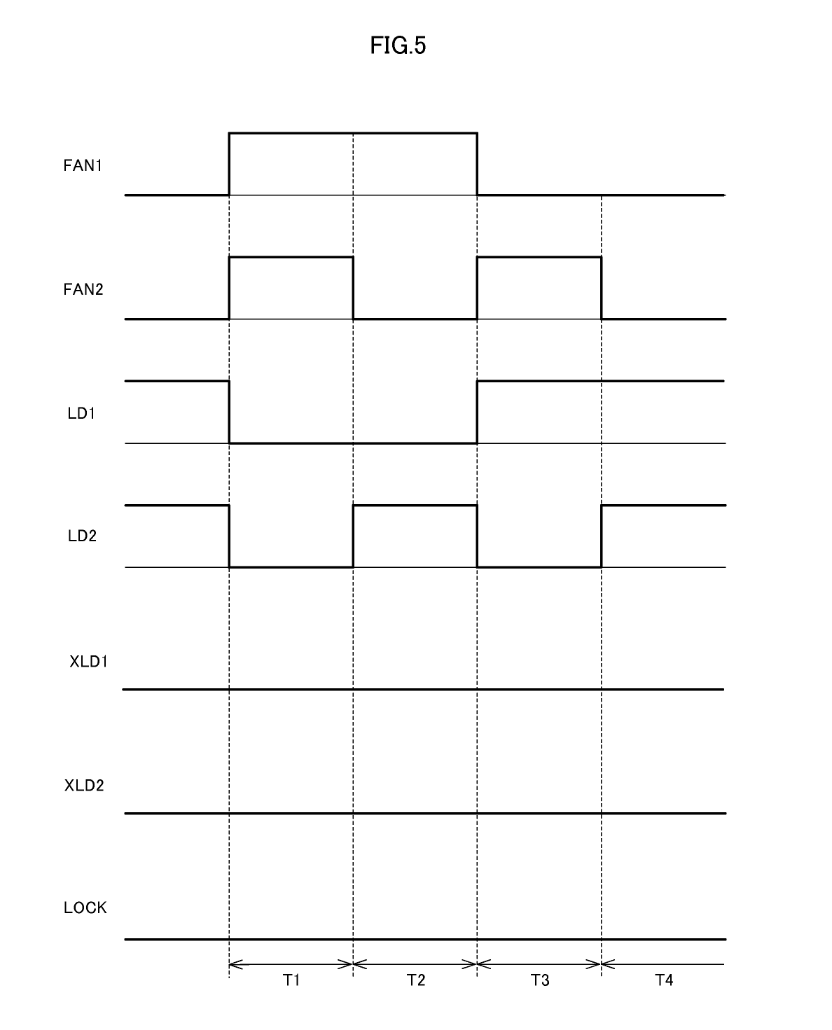

FIG. 5 shows changes of respective signals when the first control signal FAN1 or the second control signal FAN2 is changed, in the lock detecting circuit 200 shown in FIG. 4. Here, it is assumed that the first and second fan motors 210 and 212 are operating normally. If the first fan motor 210 is operating normally, the first state signal LD1 will be a signal of which level is an inverse of the first control signal FAN1. The first gate output signal XLD1 is the output signal of first gate 240 which is controlled by the first control signal FAN1 in the manner as described above and, therefore, it is always at the low level. Similarly, if the second fan motor 212 is operating normally, the second state signal LD2 will be a signal of which level is an inverse of the second control signal FAN2. The second gate output signal XLD2 is the output signal of second gate 242 which is controlled by the second control signal FAN2 in the manner as described above and, therefore, it is always at the low level. Therefore, as long as the first and second fan motors 210 and 212 are operating normally, the lock signal LOCK is always at the low level, regardless of the levels of the first and second control signals FAN1 and FAN2.

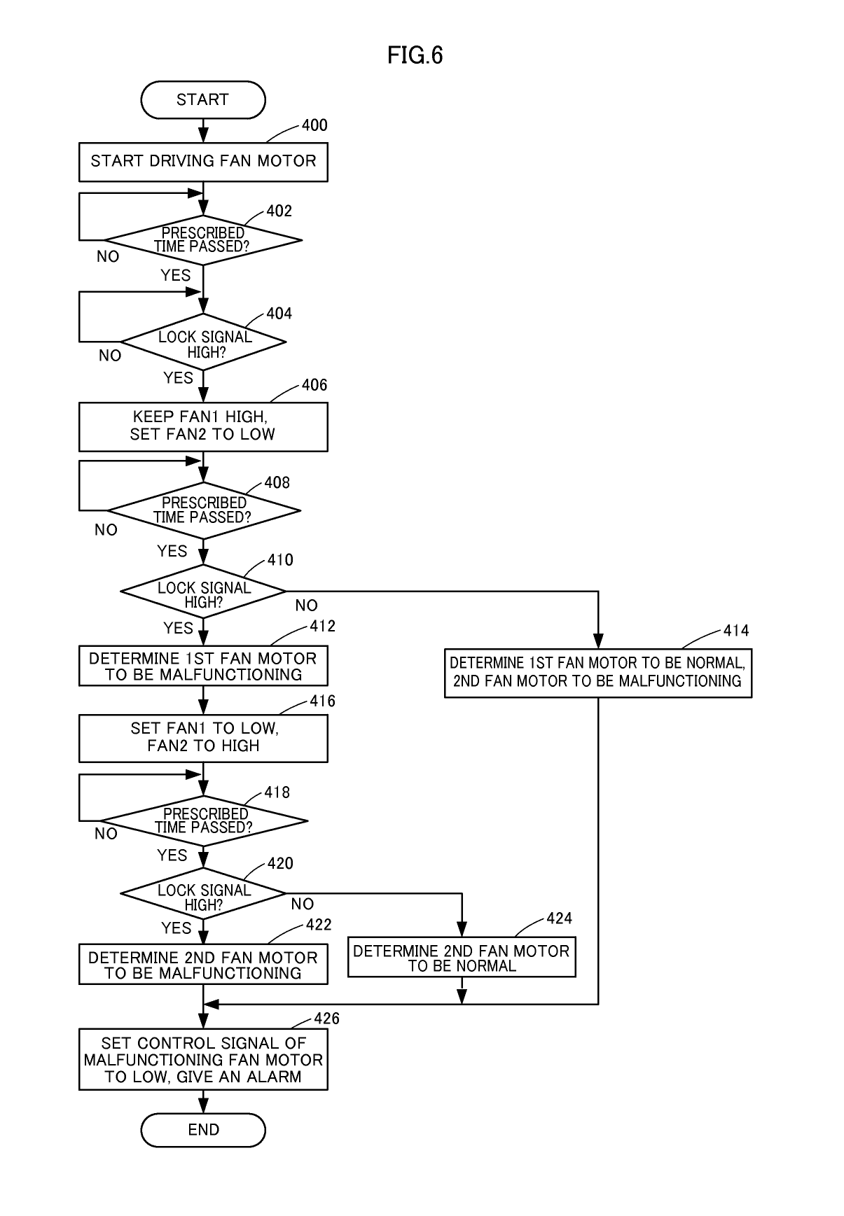

Referring to FIG. 6, the control structure of the lock detecting program executed by CPU 202 in lock detecting circuit 200 of FIG. 4 will be described.

At step 400, CPU 202 sets all control signals (first and second control signals FAN1 and FAN2) to the high level, to start driving of all fan motors (first and second fan motors 210 and 212). Further, CPU 202 obtains current time from timer 264 and stores it as start time in RAM 262.

At step 402, CPU 202 determines whether or not a prescribed time has passed after the first and second control signals FAN1 and FAN2 were set to the high level. Specifically, CPU 202 obtains the current time from timer 264 and determines whether the time difference between the obtained current time and the start time stored in RAM 262 at step 400 is equal to or longer than the prescribed time. If it is determined that the prescribed time period has passed, the control proceeds to step 404. Otherwise, step 402 is repeated. When a voltage supplied to the first and second fan motors 210 and 212 varies, it takes some time for the fan motors to attain to the state of rotation in accordance with the changed voltage. Specifically, the prescribed time period represents the wait time until stable first and second state signals LD1 and LD2 are output. The prescribed time period is, for example, 2 to 3 seconds.

At step 404, CPU 202 determines whether or not the lock signal LOCK is at the high level or not. If the lock signal LOCK is determined to be at the high level, the control proceeds to step 406. Otherwise, step 404 is repeated. During this operation, rotation of fan motors is maintained.

At step 406, CPU 202 sets the second control signal FAN2 to the low level, while maintaining the first control signal FAN1 at the high level. Specifically, CPU 202 stops the second fan motor 212 while it maintains the rotation of first fan motor 210. CPU 202 obtains information of current time from timer 264, and stores it as a start time in RAM 262. The obtained current time may be overwritten on the start time stored at step 400, or it may be stored in a different area of RAM 262.

At step 408, as at step 402, CPU 202 determines whether or not a prescribed time period has passed since the second control signal FAN2 was set to the low level. Specifically, CPU 202 obtains the current time from timer 264, and determines whether the time difference between the current time and the start time stored in RAM 262 at step 406 is equal to or longer than the prescribed time period. If it is determined that the prescribed time period has passed, the control proceeds to step 410. Otherwise, step 408 is repeated.

At step 410, CPU 202 determines whether or not the lock signal LOCK is at the high level. If the lock signal LOCK is determined to be at the high level, control proceeds to step 412. Otherwise, the control proceeds to step 414.

At step 412, CPU 202 determines that first fan motor 210 is malfunctioning. The reason is as follows. That the lock signal LOCK is still at the high level though the second control signal FAN2 was set to the low level at step 406 means the first fan motor 210, which should be rotating, is locked. Specifically, the second control signal FAN2 is at the low level and, therefore, the second gate 242 is off, and the second gate output signal XLD2 is kept at the low level by the second pull-down resistor 256. Therefore, the output signal (lock signal LOCK) of logical sum operation element 230 is at the same level as the first gate output signal XLD1. Here, since the lock signal LOCK is at the high level, the first gate output signal XLD1 is at the high level. Since the first gate 240 is on (the first control signal FAN1 is at the high level), the first gate output signal XLD1 and the first state signal LD1 are naturally at the same level. Specifically, the first state signal LD1 is at the high level, same as the first gate output signal XLD1. This means that the first fan motor 210 is stopped (locked), even though the first controls signal FAN1 is at the high level.

At step 414, CPU 202 determines that the first fan motor 210 is normal and the second fan motor is locked. As described with respect to step 412, the lock signal LOCK (output signal of logical sum operation element 230) is at the same level as the first gate output signal XLD1. Here, since the lock signal LOCK is at the low level, the first gate output signal XLD1 is also at the low level. Since the first gate 240 is on (the first control signal FAN1 is at the high level), the first gate output signal XLD1 and the first state signal LD1 are naturally at the same level. Specifically, the first state signal LD1 is at the low level, same as the first gate output signal XLD1. Thus, it is understood that the first fan motor 210 is rotating normally. On the other hand, since the high level lock signal LOCK is detected at step 404, it follows that at least one of the first and second fan motors 210 and 212 must be locked. Since the first fan motor 210 is rotating normally, it is understood that the second fan motor 212 is locked. Then, the control proceeds to step 426.

At step 412, it is known that the first fan motor 210 is locked. At this stage, however, it is unclear whether the second fan motor is locked or not. Therefore, at step 416, CPU 202 sets the first control signal FAN1 to the low level, and sets the second control signal FAN2 to the high level. Specifically, CPU 202 stops power supply to the first fan motor 210 (turns off first switch 220), and executes power supply to second fan motor 212 (turns on second switch 222). Further, CPU 202 obtains the current time from timer 264 and stores it as a start time in RAM 262.

At step 418, as at step 402, CPU 202 determines whether or not a prescribed time period has passed since the second control signal FAN2 was set to the high level. Specifically, CPU 202 obtains the current time from timer 264, and determines whether time difference between the current time and the start time stored in RAM 262 at step 416 is equal to or longer than the prescribed time period. If it is determined that the prescribed time period has passed, the control proceeds to step 420. Otherwise, step 418 is repeated.

At step 420, CPU 202 determines whether or not the lock signal LOCK is at the high level. If the lock signal LOCK is determined to be at the high level, the control proceeds to step 422. Otherwise, the control proceeds to step 424.

At step 422, CPU 202 determines that the second fan motor is malfunctioning and is locked. Here, the first control signal FAN1 and the first gate output signal XLD1 are at the low level and, hence, the lock signal LOCK (output signal of logical sum operation element 230) is at the same level as the second gate output signal XLD2. Since the lock signal LOCK is at the high level, the second gate output signal XLD2 is at the high level. The second control signal FAN2 has been set to the high level at step 416 and, therefore, the level of second gate output signal XLD2 is the same as the level of second state signal LD2. Therefore, the second state signal LD2 is at the high level, and hence, it is understood that the second fan motor 212 is locked.

At step 424, CPU 202 determines that the second fan motor 212 is operating normally. As described with respect to step 422, the lock signal LOCK (output signal of logical sum operation element 230) is at the same level as the second gate output signal XLD2. Since the lock signal LOCK is at the low level, the second gate output signal XLD2 is at the low level. The second control signal FAN2 has been set to the high level at step 416 and, therefore, the level of second gate output signal XLD2 is the same as the level of the second state signal LD2. Therefore, the second state signal LD2 is at the low level, and it is understood that the second fan motor 212 is rotating normally.

At step 426, CPU 202 sets the control signal for the fan motor that is determined to be malfunctioning (locked) to the low level and gives an alarm. The alarm may be a prescribed message displayed on a display unit (for example, a display panel of a tough-panel display) of the image forming apparatus. Then, the program ends.

By way of example, when step 414 is executed, the second control signal FAN2 is set to the low level, and a message “second fan motor locked” is displayed. When steps 412 and 424 are executed, the first controls signal FAN1 is set to the low level, and a message “first fan motor locked” is displayed. When steps 412 and 422 are executed, the first and second control signals FAN1 and FAN2 are set to the low level, and a message “first and second fan motors locked” is displayed.

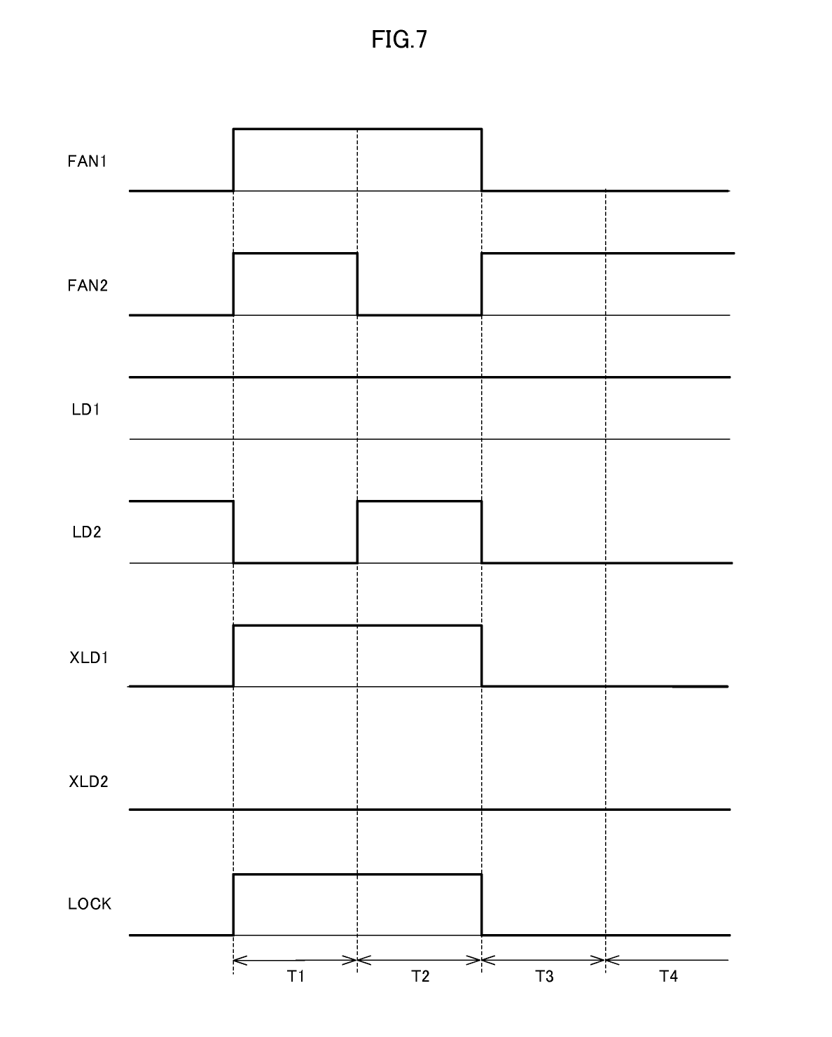

Referring to FIGS. 7 to 9, the operation of lock detecting circuit 200 of FIG. 4 will be described more specifically. FIG. 7 shows a state in which the first fan motor 210 is locked and the second fan motor 212 is operating normally.

In the first time period T1, CPU 202 sets the first and second control signals FAN1 and FAN2 from the low level to the high level, and supplies power to the first and second fan motors 210 and 212 (step 400). Since the first fan motor 210 is locked, the first state signal LD1 is at the high level in the first time period T1. Since the first control signal FAN1 is at the high level, the first gate 240 is turned on, and the first gate output signal XLD1 attains to the high level, same as the first state signal LD1. On the other hand, the second fan motor 212 is rotating normally and, therefore, the second state signal LD2 is at the low level, and since the second control signal FAN2 is at the high level, the second gate 242 is turned on, and the second gate output signal XLD2 is at the low level, same as the second state signal LD2. Therefore, the output signal of logical sum operation element 230 (lock signal LOCK) attains to the high level. CPU 202 detects that the lock signal LOCK is at the high level (step 404).

In the second time period T2, CPU 202 sets the second control signal FAN2 to the low level while it maintains the first control signal FAN1 at the high level (step 406). Since the first control signal FAN1 is kept at the high level, the first gate output signal XLD1 remains high. Since the power supply to the second fan motor 212 is stopped, the second state signal LD2 attains to the high level. The second control signal FAN2, however, is at the low level and, therefore, the second gate 242 is off and the second gate output signal XLD2 is at the low level. Therefore, the lock signal LOCK, which is the output signal of logical sum operation element 230, is kept at the high level, and CPU 202 determines that the first fan motor is locked (steps 410 and 412).

In the third time period T3, in order to determine whether the second fan motor 212 is locked or not, CPU 202 sets the first control signal FAN1 to the low level, and sets the second control signal FAN2 to the high level (step 416). Consequently, the power supply to the first fan motor 210 is stopped and hence, the first state signal LD1 attains to the high level. The first control signal FAN 1, however, is at the low level and, hence, the first gate 240 is off and the first gate output signal XLD1 attains to the low level. On the other hand, the second fan motor 212 rotates normally and, therefore, the second state signal LD2 attains to the low level, and since the second control signal FAN2 is at the high level, the second gate 242 is turned on, and the second gate output signal XLD2 attains to the low level, as is the second state signal LD2. Thus, the output signal of logical sum operation element 232 (lock signal LOCK) attains to the low level. Specifically, CPU 202 detects that the lock signal LOCK attained to the low level, and determines that the second fan motor 212 is normal (steps 420 and 424).

As described above, CPU 202 detects that the lock signal LOCK has attained to the high level in the first time period T1, and thereafter, by setting only one of the first and second control signals FAN1 and FAN2 to the low level in the second and third time periods T2 and T3, CPU 202 can identify the first fan motor 210 as the locked one. Thereafter, in the fourth time period T4, CPU 202 maintains the second control signal FAN2 of the normally operating fan motor 212 at the high level, and maintains the first control signal FAN1 of the locked first fan motor 210 at the low level, respectively (step 426).

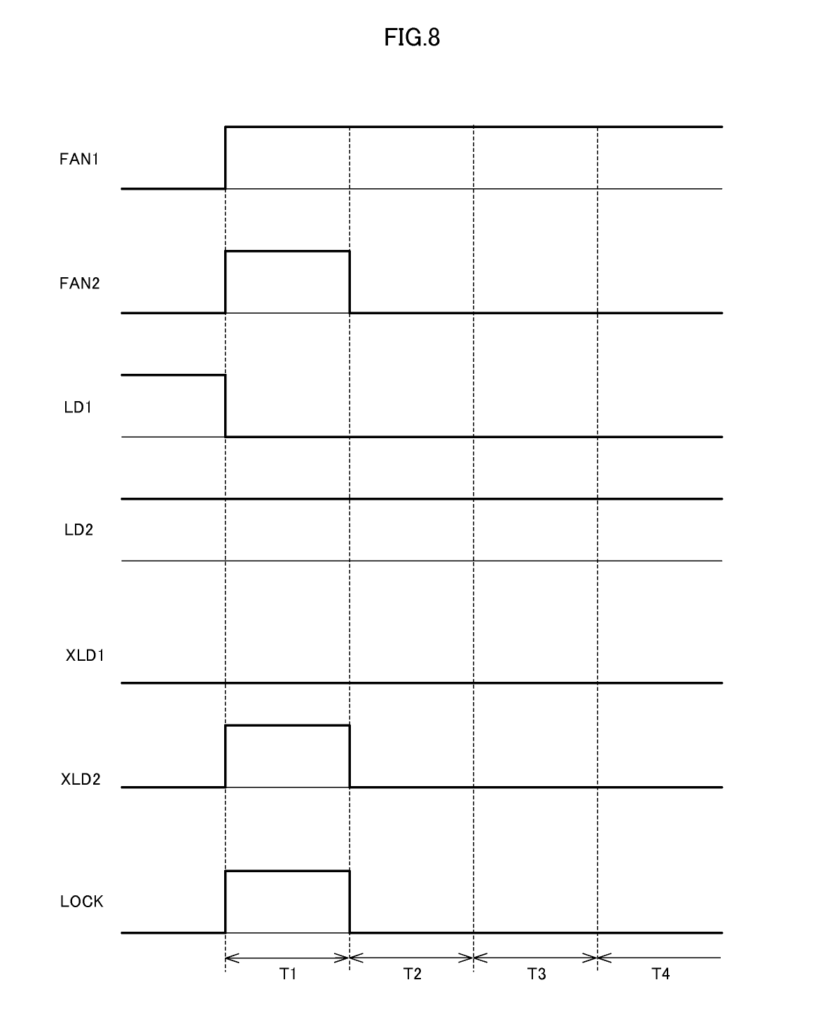

FIG. 8 shows a state in which the first fan motor 210 is normal and the second fan motor 212 is locked. In the first time period T1, CPU 202 sets the first and second control signals FAN1 and FAN2 from the low level to the high level to supply electric power to the first and second fan motors 210 and 212 (step 400), and then, detects that the lock signal LOCK is at the high level (step 404). Therefore, in the second time period T2 of FIG. 8, CPU 202 maintains the first control signal FAN1 at the high level and sets the second control signal FAN2 to the low level, similar to the time period T2 shown in FIG. 7 (step 406). As a result, the first gate 240 turns on, the level of first gate output signal XLD1 attains to the low level, same as the first state signal LD1 (since the first fan motor 210 is rotating), the second gate 242 turns off and the level of the second gate output signal XLD2 attains to the low level. Therefore, the lock signal LOCK attains to the low level, and detecting this, CPU 202 determines that the first fan is normal and the second fan motor 212 is locked (step 414).

Then, from the third time period T3, CPU 202 maintains the first control signal FAN1 of normally operating first fan motor 210 at the high level, and maintains the second control signal FAN2 of locked second fan motor 212 at the low level, respectively (step 426).

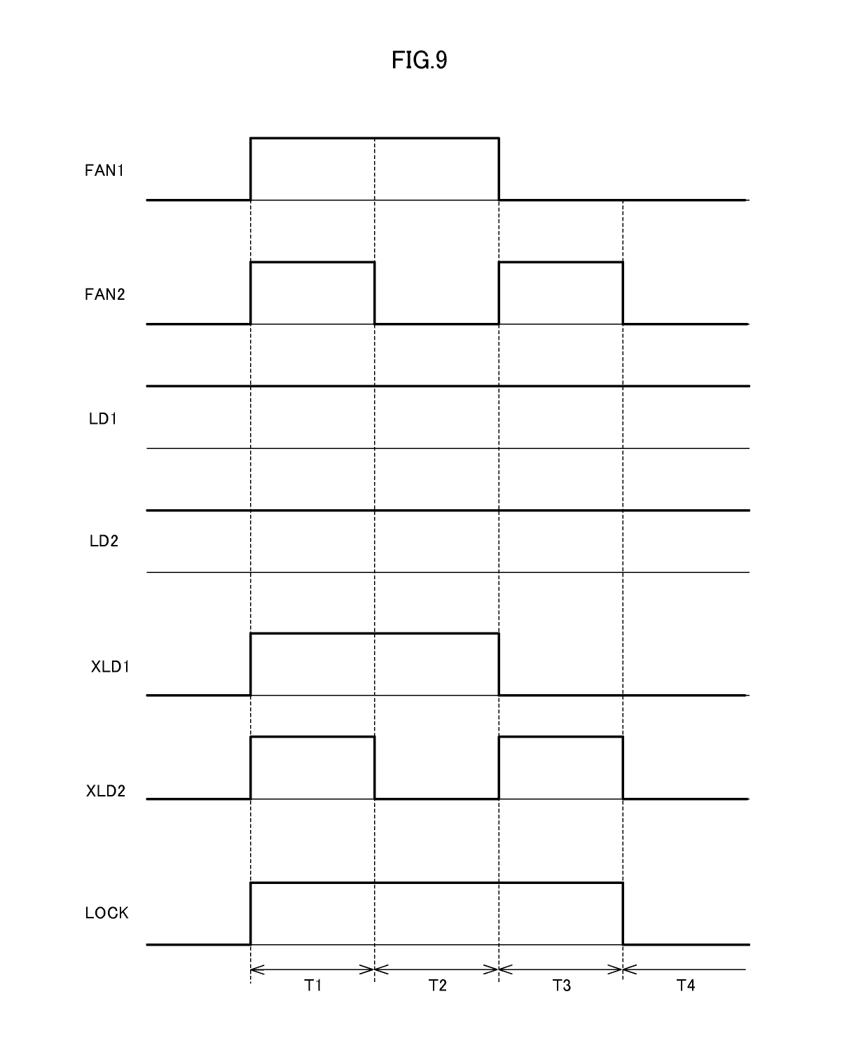

FIG. 9 shows a state in which the first and second fan motors 210 and 212 are locked. In the first time period T1, CPU 202 sets the first and second control signals FAN1 and FAN2 from the low level to the high level to supply electric power to the first and second fan motors 210 and 212 (step 400), and then detects that the lock signal LOCK is at the high level (step 404). Therefore, in the second time period T2 of FIG. 9, CPU 202 maintains the first control signal FAN1 at the high level and sets the second control signal FAN2 to the low level, as in the second time period T2 of FIG. 7 (step 406). As a result, the first gate 240 turns on, the level of the first gate output signal XLD1 attains to the same high level as the first state signal LD1 (since the first fan motor 210 is locked), the second gate 242 turns off, and the level of second gate output signal XLD2 attains to the low level. Therefore, the lock signal LOCK is kept high. Thus, CPU 202 determines that the first fan motor 210 is locked (steps 410 and 412).

In the third time period T3, CPU 202 sets the first control signal FAN1 to the low level and sets the second control signal FAN2 to the high level in order to determine whether the second fan motor 212 is locked (step 416). Consequently, the first gate 240 turns off, and the first gate output signal XLD1 attains to the low level. The second gate 242 turns on, and the second gate output signal XLD2 attains to the same high level as the second state signal LD2 (as the second fan motor 212 is locked). Therefore, since the lock signal LOCK remains at the high level, CPU 202 determines that the second fan motor 212 is locked (steps 420 and 422).

Thereafter, in the fourth time period T4, CPU 202 sets the first and second control signals FAN1 and FAN2 to the low level, since the first and second fan motors 210 and 212 are locked (step 426).

From the foregoing, it is understood that the locked fan motor can be identified from the first and second fan motors 210 and 212. Therefore, it becomes possible to stop power supply to the locked fan motor, and to notify the user (including an administrator) of the locked fan motor. Thus, the user can stop the image forming apparatus as needed and immediately ask a service person for a quick repair, when, for example, the temperature in the image forming apparatus could be high and could result in damage.

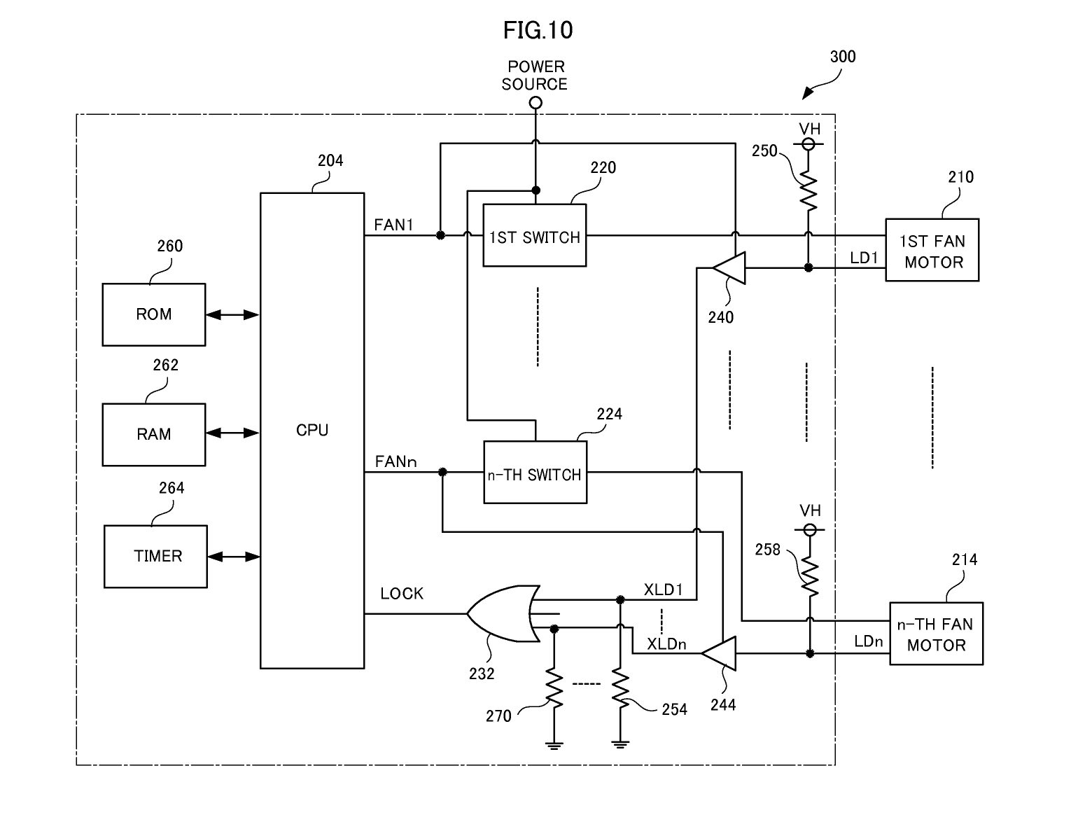

Though an example having two fan motors has been described above, the number of fan motors is not limited thereto. It is also possible to identify a locked fan motor among three or more fan motors, using a circuit structure similar to that shown in FIG. 4, for example, by a lock detecting circuit 300 shown in FIG. 10, using one input port of CPU. In order to control n (n>3) fan motors (first to n-th fan motors 210 to 214), lock detecting circuit 300 is provided with n switches (first to n-th switches 220 to 224), n gates (first to n-th gates 240 to 244), n pull-up resistors (first to n-th pull-up resistors 250 to 258), n pull-down resistors (first to n-th pull-down resistors 254 to 270), a logical sum operation element 232, a CPU 204, an ROM 260, an RAM 262, and a timer 264. Lock detecting circuit 300 of FIG. 10 is different from lock detecting circuit 200 of FIG. 4 in that it includes n sets of a switch, a gate, a pull-up resistor and a pull-down resistor, that CPU 204 outputs n control signals, and that logical sum operation element 232 has n inputs. The operation of each component is the same as that of FIG. 4 and, therefore, description thereof will not be repeated.

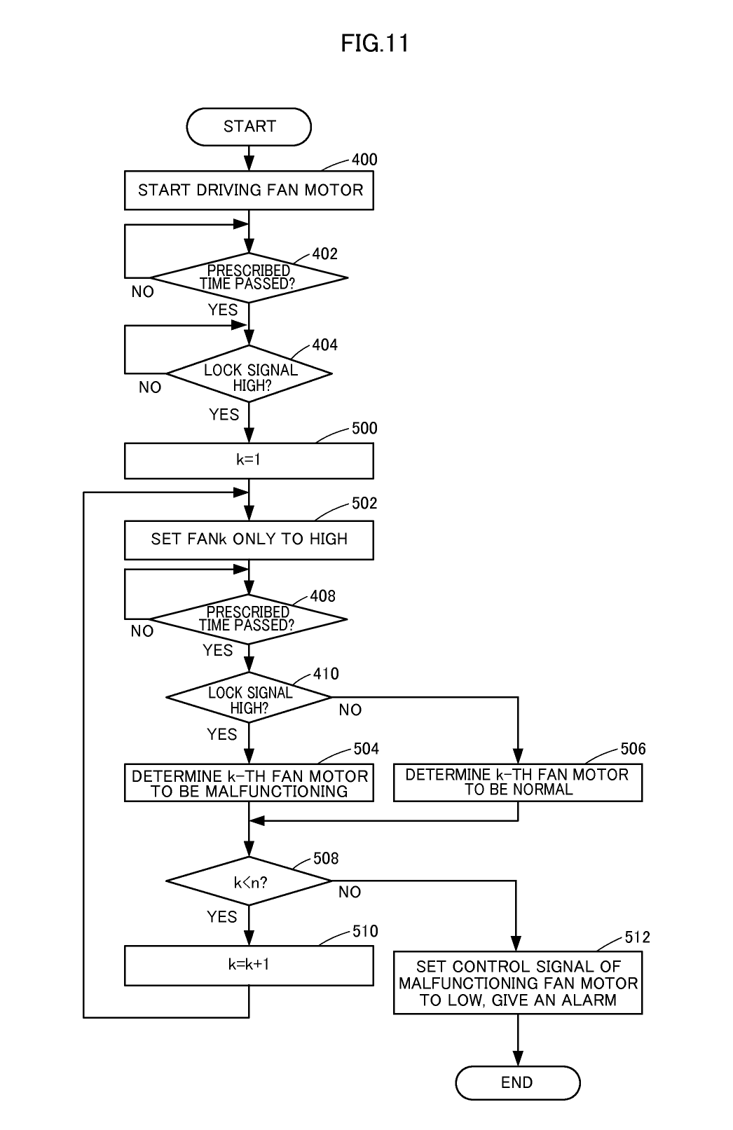

Referring to FIG. 11, the control structure of lock detecting program executed by CPU 204 in lock detecting circuit 300 shown in FIG. 10 will be described. In the following, the steps having the same reference characters as in FIG. 6 are the same as those of FIG. 6 and, therefore, description thereof will not be repeated.

If it is detected at step 404 that the lock signal LOCK is at the high level, at step 500, CPU 204 sets a repetition counter k to 1.

At step 502, CPU 204 sets only the k-th control signal to the high level, and sets other control signals at the low level. Thus, the k-th gate controlled by the k-th control signal turns on and other gates turn off. Therefore, only the k-th gate output signal attains to the same level as the k-th state signal, and other gate output signals attain to the low level because of the pull-down resistors. Therefore, the output signal (lock signal LOCK) of logical sum operation element 232 is determined by the level of k-th gate output signal, that is, the level of k-th state signal. If the k-th fan motor is rotating normally, the k-th state signal is at the low level and the lock signal LOCK will be at the low level. If the k-th fan motor is locked, the k-th state signal is at the high level and the lock signal LOCK becomes high.

After a prescribed time period, if it is detected at step 410 that the lock signal LOCK is at the high level, at step 504, CPU 204 determines that the k-th fan motor is malfunctioning and it is locked. CPU 204 stores information representing the k-th fan motor (such as the number “k”) in association with the result of determination (such as “1”), in RAM 262.

On the other hand, after a prescribed time period, if it is determined at step 410 that the lock signal LOCK is at the low level, at step 506, CPU 204 determines that the k-th fan motor is operating normally. CPU 204 stores information representing the k-th fan motor (such as the number “k”) in association with the result of determination (such as “0”), in RAM 262.

At step 508, CPU 204 determines whether the counter k is smaller than n (the number of fan motors as the object of control). If it is determined to be smaller, the control proceeds to step 510. Otherwise, the control proceeds to step 512.

At step 510, CPU 204 adds 1 to the current counter k and uses the resulting value as new counter k, and then the control returns to step 502 and step 502 and steps following step 502 are repeated. Thus, CPU 204 determines whether any of the n fan motors is locked or not, and stores the result in RAM 262.

At step 512, CPU 204 sets each control signal of the fan motor of which result of determination stored in RAM 262 is “1” to the low level, to give an alarm that the corresponding fan motor is locked.

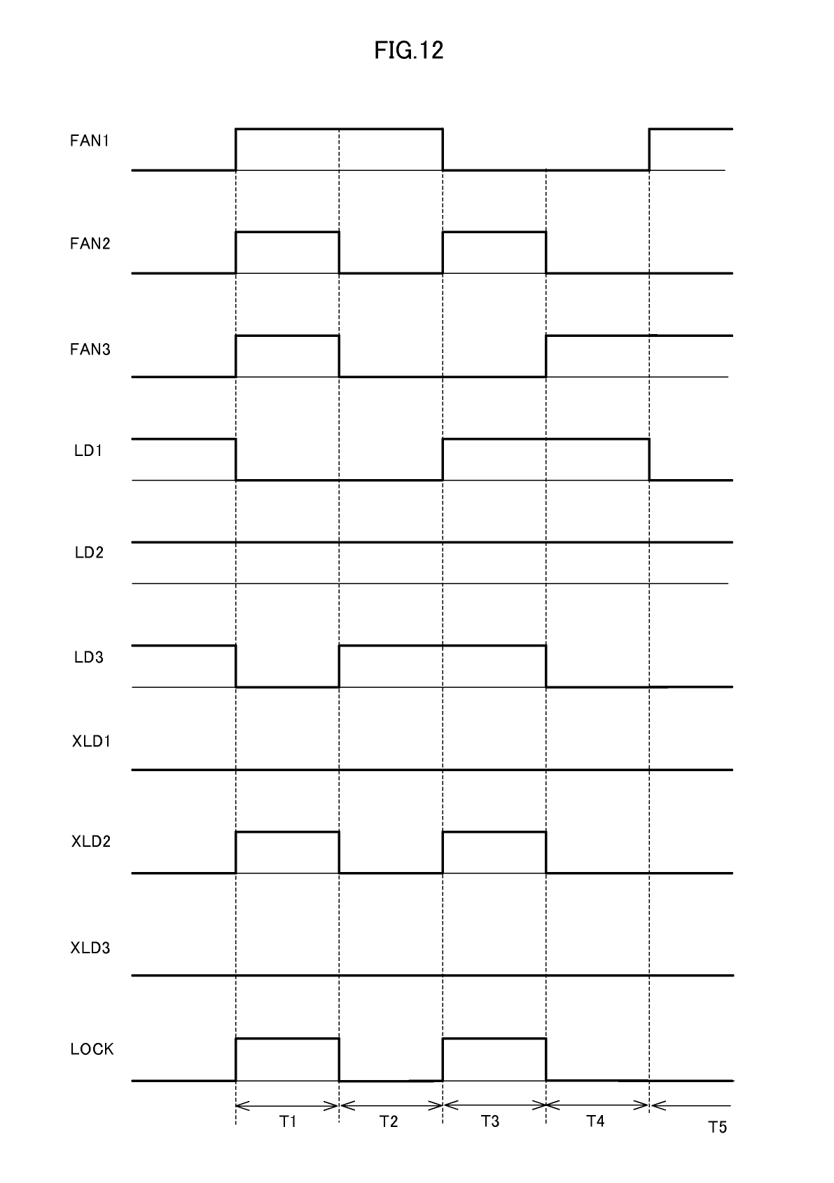

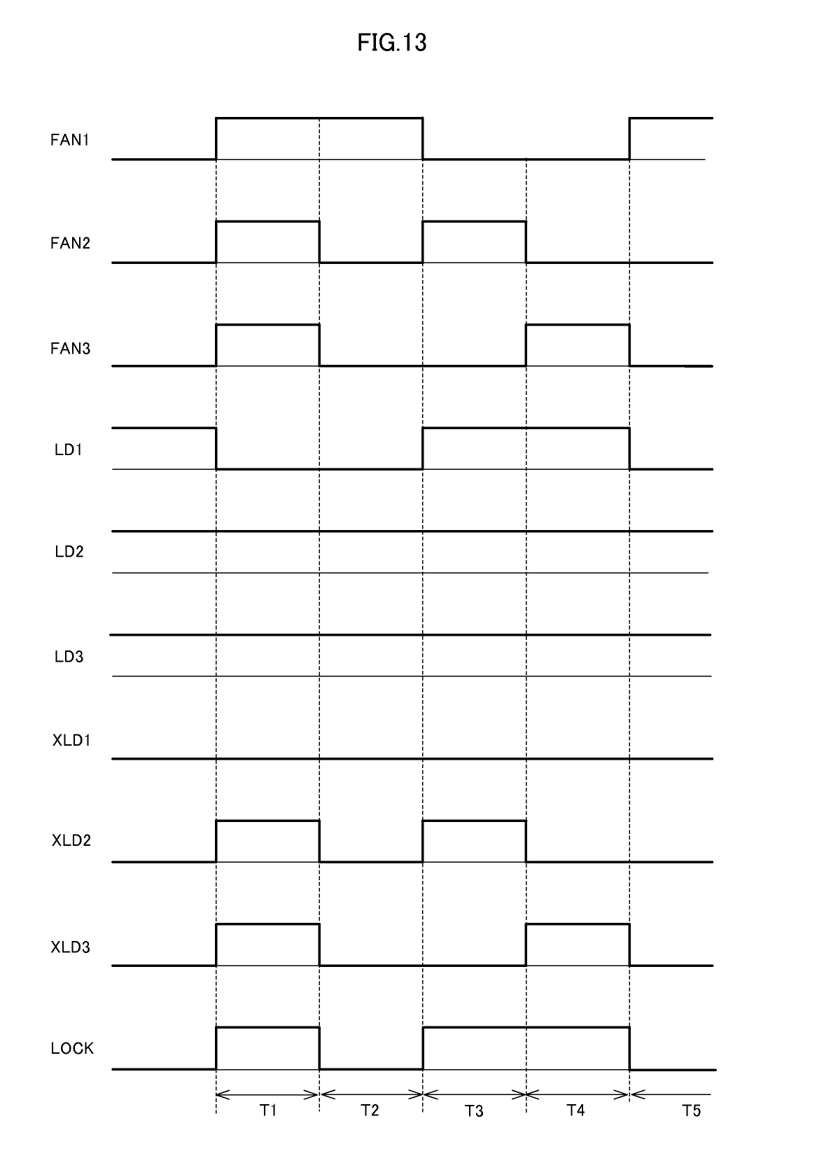

Referring to FIGS. 12 and 13, the operation of lock detecting circuit 300 of FIG. 11 will be described in greater detail. FIG. 12 is a timing chart for controlling three fan motors, when the second fan motor is locked and the first fan motor 210 and the third fan motor are normal.

In the first time period T1, CPU 204 sets the first control signal FAN1 to the third control signal from the low level to the high level, to supply power to the first fan motor 210 to the third fan motor (step 400). Since the second fan motor is locked, in the first time period T1, the second state signal is at the high level. Since the second control signal is at the high level, the second gate turns on, and the second gate output signal attains to the same high level as the second state signal. On the other hand, since the first fan motor 210 and the third fan motor are operating normally, the first state signal LD1 and the third state signal are at the low level, and the first control signal FAN1 and the third control signal are at the high level. Thus, the first gate 240 and the third gate turn on, and the first gate output signal XLD1 and the third gate output signal attain to the low level, same as the first state signal LD1 and the third state signal, respectively. Therefore, the output signal of logical sum operation element 232 (lock signal LOCK) attains to the high level. Specifically, CPU 204 detects that the lock signal LOCK is at the high level (step 404).

In the second time period T2 (k=1), CPU 204 maintains the first control signal FAN1 at the high level, and sets the second and third control signals to the low level (step 502). Thus, power supply to the second and third fan motors is stopped, and hence, the second and third state signals attain to the high level. The second and third control signals, however, are at the low level and, therefore, the second and third gates are off, and the second and third gate output signals are kept at the low level. Therefore, the lock signal LOCK (output signal of logical sum operation element 232) is at the same level as the first gate output signal XLD1. Since the first gate 240 is on (the first control signal FAN1 is at the high level), the level of first gate output signal XLD1 is the same low level as the first state signal LD1 (the first fan motor 210 is rotating normally). Specifically since CPU 204 detects the lock signal LOCK at the low level, it determines that the first fan motor 210 is normal (step 506).

In the third time period T3 (k=2), the second control signal is set to the high level and the first control signal FAN1 and the third control signal are set to the low level (step 502). Consequently, the power supply to the first fan motor 210 and to the third fan motor is stopped, and hence the first state signal LD1 and the third state signal attain to the high level. The first control signal FAN1 and the third control signal, however, are at the low level and, therefore, the first gate 240 and the third gate are off, and the first gate output signal XLD1 and the third gate output signal remain at the low level. Therefore, the lock signal LOCK (output signal of logical sum operation element 232) has the same level as the second gate output signal. Since the second gate is on (the second control signal is at the high level), the second gate output signal is at the same high level as the second state signal (the second fan motor is locked). Specifically, since CPU 204 detects the lock signal LOCK at the high level, it determines that the second fan motor is malfunctioning and is locked (step 504).

In the fourth time period T4 (k=3), the third control signal is set to the high level, and the first control signal FAN1 and the second control signal are set to the low level (step 502). Thus, the power supply to the first fan motor 210 and to the second fan motor is stopped, and hence, the first state signal LD1 and the second state signal attain to the high level. Since the first control signal FAN1 and the second control signal are at the low level, the first gate 240 and the second gate are off, and the first gate output signal XLD1 and the second gate output signal are kept at the low level. Therefore, the lock signal (output signal of logical sum operation element 232) has the same level as the third gate output signal. Since the third gate is on (the third control signal is at the high level), the level of the third gate output signal is the same low level as the third state signal (the third fan motor is rotating normally). Specifically, since the CPU 204 detects the lock signal LOCK at the low level, it determines that the third fan motor is normal (step 506).

Through the above-described process steps, the locked second fan motor 212 can be identified. Therefore, in the fifth time period T5, CPU 204 sets the first control signal FAN1 and the third control signal of normally operating first fan motor 210 and the third fan motor to the high level, and sets the second control signal of the locked second fan motor to the low level (step 512).

FIG. 13 is a timing chart when the second and third fan motors are locked and the first fan motor 210 is normal.

In the first time period T1, CPU 204 sets the first control signal FAN1 to the third control signal from the low level to the high level and supplies electric power to the first fan motor 210 to the third fan motor (step 400). Since the second fan motor 212 and the third fan motor are locked, in the first time period T1, the second and third state signals are at the high level. Since the second and third control signals are at the high level, the second and third gates turn on, and the second and third gate output signals attain to the high level, same as the second and third state signals, respectively. Therefore, the output signal of logical sum operation element 232 (lock signal LOCK) attains to the high level. Specifically, CPU 204 detects that the lock signal LOCK is at the high level (step 404). Since the first fan motor 210 is rotating normally, the first state signal LD1 is at the low level, the first control signal FAN1 is at the high level and, therefore, the first gate 240 turns on and the first gate output signal XLD1 is at the low level, same as the first state signal LD1.

In the second time period T2 (k=1), CPU 204 maintains the first control signal FAN1 at the high level and sets the second and third control signals to the low level (step 502). Thus, the power supply to the second and third fan motors is stopped and, hence, the second and third state signals attain to the high level. The second and third control signals, however, are at the low level and, therefore, the second and third gates are off and the second and third gate output signals are kept at the low level. Therefore, the lock signal LOCK (output signal of logical sum operation element 232) is at the same level as the first gate output signal XLD1. Since the first gate 240 is on (the first control signal FAN1 is at the high level), the level of first gate output signal XLD1 is the low level, same as the first state signal LD1 (the first fan motor 210 is rotating normally). Specifically, since CPU 204 detects the lock signal LOCK at the low level, it determines that the first fan motor 210 is normal (step 506).

In the third time period T3 (k=2), the second control signal is set to the high level and the first control signal FAN1 and the third control signal are set to the low level (step 502). Thus, the power supply to the first fan motor 210 and to the third fan motor is stopped and, hence, the first state signal LD1 and the third state signal attain to the high level. Since the first control signal FAN1 and the third control signal are at the low level, the first gate 240 and the third gate are off, and the first gate output signal XLD1 and the third gate output signal are kept at the low level. Therefore, the lock signal LOCK (output signal of logical sum operation element 232) is at the same level as the second gate output signal. Since the second gate is on (the second control signal is at the high level), the level of the second gate output signal is the same high level as the second state signal (the second fan motor is locked). Specifically, CPU 204 detects the lock signal LOCK at the high level, and hence, it determines that the second fan motor is malfunctioning and is locked (step 504).

In the fourth time period T4 (k=3), the third control signal is set to the high level and the first control signal FAN1 and the second control signal are set to the low level (step 502). Thus, the power supply to the first fan motor 210 and to the second fan motor is stopped and, hence, the first state signal LD1 and the second state signal attain to the high level. The first control signal FAN1 and the second control signal, however, are at the low level, and hence, the first gate 240 and the second gate are off, and the first gate output signal XLD1 and the second gate output signal are kept at the low level. Therefore, the lock signal LOCK (output signal of logical sum operation element 232) has the same level as the third gate output signal. Since the third gate is on (the third control signal is at the high level), the level of the third gate output signal is the high level, same as the third state signal (the third fan motor is locked). Specifically, since CPU 204 detects the lock signal LOCK at the high level, it determines that the third fan motor is malfunctioning and is locked (step 504).

Through the above-described process steps, the locked second and third fan motors are identified. Therefore, in the fifth time period T5, CPU 204 sets the first control signal FAN1 of normally operating first fan motor 210 to the high level, and sets the second and third control signals of the locked second and third fan motors to the low level (step 512).

From the foregoing, it is understood that the locked fan motor or motors can be identified from the first fan motor 210 to the third fan motor. Therefore, it becomes possible to stop power supply to the locked fan motor, and to notify the user (including an administrator) of the locked fan motor. Thus, the user can stop the image forming apparatus as needed and to immediately ask a service person for quick repair, when, for example, the temperature in the image forming apparatus could be high and could result in damage.

Though examples in which only the second fan motor is locked (FIG. 12) and the second and third fan motors are locked (FIG. 13) have been described above, it is possible to identify locked fan motor or motors in the similar manner even when the combination of locked fan motors is different. Further, it is also possible to identify locked fan motor or motors in the similar manner when four or more fan motors are provided.

Though an example in which the level of lock signal LOCK is determined by setting to the high level the control signal of only one fan motor among a plurality of fan motors has been described in the foregoing, it is not limiting. By way of example, only the control signal of one fan motor may be set to the low level and the control signals of other fan motors may be set to the high level. If the number of fans is large and only one fan is driven, it is possible that the temperature inside the apparatus undesirably increases. In such a situation, it is possible to set the control signals of fan motors one by one to the low level and when the lock signal LOCK attains to the low level, the corresponding fan motor can be determined to be locked. Generally, it is unlikely that a plurality of fan motors are locked simultaneously. Therefore, it is possible by this method to identify the locked fan.

If the lock signal LOCK does not attain to the low level even when the control signals of fan motors are set to the low level one by one, it means that a plurality of fan motors are locked. Then, an alarm to that effect may be given, and the user can stop the image forming apparatus.

Alternatively, a combination of setting control signals of a plurality of fan motors to the high level or to the low level may be determined avoiding overlapping, and determination may be made as to whether the lock signal LOCK attains to the low level, using such a combination. Typically, the number of fans controlled by one CPU is around 10 and the number of combinations is not so large. Therefore, even when a plurality of fan motors should be locked, the locked fan motors could be identified in a relatively short period of time.

In the lock detecting circuits shown in FIGS. 4 and 10, the gates are not limited to FETs. The gate may be any element that is on/off controlled by a control signal, outputs a signal of a level in accordance with an input signal (state signal) (the same level as the input signal, or the inverted level of the input signal) if the control signal is at the level (for example, high level) for supplying electric power to the fan motor, and outputs a signal of a level corresponding to the state signal while the fan motor is rotating (if the gate outputs the input signal without inversion, the same level as the state signal, and if the gate outputs the inverted input signal, the inverted level of the input signal), if the control signal is at the level not for supplying electric power to the fan motor. Specifically, the interpretation of signal levels may be determined as one chooses. It is possible to determine that the fan motor is rotating if the signal is at the low level and the fan motor is not rotating if the signal is at the high level (the same determination as the state signal), or to determine that the fan motor is rotating if the signal is at the high level and the fan motor is not rotating if the signal is at the low level (opposite determination to the state signal).

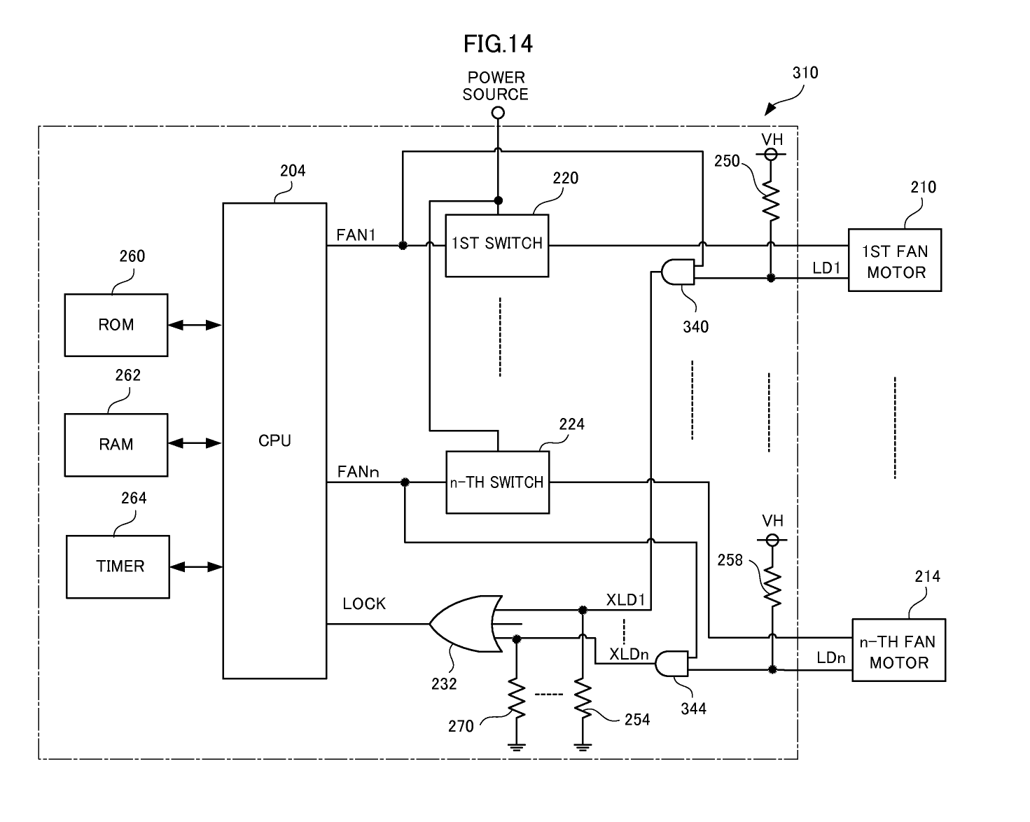

Therefore, by way of example, the gates of FIGS. 4 and 10 may be logical product operation elements (AND gates), as in a lock detecting circuit 310 shown in FIG. 14. Specifically, in place of the first gate 240, an AND gate 340 may be used, which has the first control signal FAN1 and the first state signal LD1 as inputs and outputs the first gate output signal XLD1. In this case also, if the first control signal FAN1 is at the high level, the first gate output signal XLD1 attains to the same level as the first state signal LD1, and if the first control signal FAN1 is at the low level, the first gate output signal XLD1 attains to the low level, same as the state signal when the fan motor is normal. If an AND gate is used in place of the first gate 240, pull-down resistors 254 and 270 may be omitted.

Further, in place of the AND gate in lock detecting circuit 310 shown in FIG. 14, a negative logical sum operation element (NOR gate) may be used. In that case, the control signal is input through an inverter to the NOR gate. Here, the output signal of NOR gate will be the inversion signal of the state signal and, therefore, the meaning of output signal level from the NOR gate is opposite to that of the state signal. To have the output signal level of NOR gate bear the same meaning as the state signal, the output of NOR gate should be input to the logical sum operation element 232 through an inverter. It is also possible to use other logic circuits.

Further, though examples in which the switch (first switch 220 and the like) turns on when the control signal is at the high level have been described with reference to FIGS. 4 and 10, these examples are not limiting. A switch that turns on when the control signal is at the low level may be used. In that case, an element that turns on at the low level, such as an NMOS type FET, may be used for the gate (first gate 240 and the like). In this case also, an exclusive logical sum operation element (XOR gate), a logical product operation element (AND gate) or the like may be used as the gates of FIGS. 4 and 10. When an AND gate is used, the control signal may be input to the gate through an inverter.

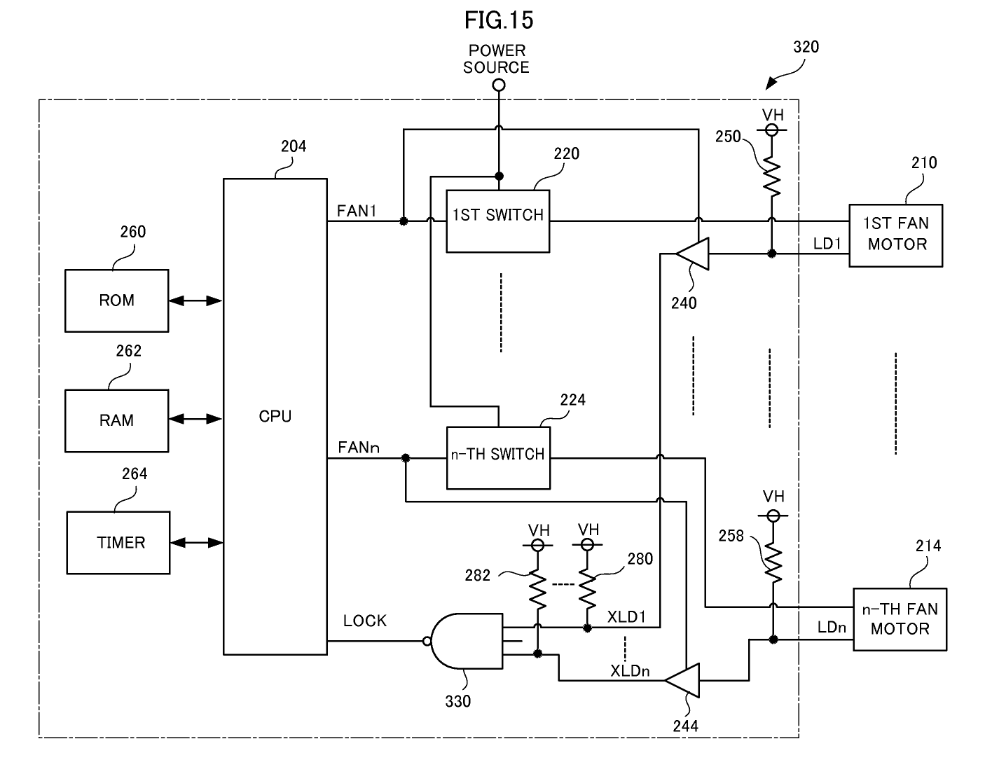

With reference to FIGS. 4 and 10, examples in which the state signal of fan motor is at the low level when the fan motor is rotating and at the high level when the fan motor is stopped have been described. These examples, however, are not limiting. The state signal of fan motor may be at the high level when the fan motor is rotating and at the low level when the fan motor is stopped. In that case, each state signal may be input to the corresponding gate through an inverter, in FIG. 4 or 10. Alternatively, a negative logical product operation element (NAND gate) 330 may be used in place of the logical sum operation element, as in a lock detecting circuit 320 shown in FIG. 15, without using an inverter. If a plurality of input signals to NAND gate 330 are all at the high level (indicating that the fan motor is rotating), the output signal of NAND gate 330 (lock signal LOCK) attains to the low level (indicating that lock has not occurred), and if at least one input signal is at the low level (fan motor is locked), the output signal attains to the high level (indicating locked state). Therefore, by changing the control signals, it is possible to identify the locked fan motor, in the similar manner as described above. It is noted that in FIG. 15, the first to n-th pull-down resistors 254 to 270 of FIG. 11 are replaced by pull-up resistors 280 and 282. This is to have the input signals to NAND gate 234 set to the signal level (high level) when the fan motor is rotating, when the first to n-th gates 240 to 244 are off.

In the example of FIG. 15, when the lock signal LOCK is at the high level, CPU 204 determines that a motor is locked, and if the lock signal LOCK is at the low level, it determines that the operation is normal. This example, however, is not limiting. By way of example, NAND gate 330 may be replaced by an AND gate, and CPU 204 may determine that a motor is locked if the lock signal LOCK is at the low level and that the operation is normal when the lock signal LOCK is at the high level. If arranged in this manner, the meaning of high and low levels of the lock signal LOCK becomes the same as that of fan motor state signal (the state signal is at the high level when the fan motor is rotating and at the low level when the motor is stopped).

As described above, how the CPU interprets the level of lock signal LOCK may be determined as one chooses. Therefore, the element that can replace logical sum operation element 232 of FIG. 10 may be any element of which output signal level when the plurality of input signals are at the same level as the state signal when the fan motor is rotating is different from the output signal level when at least one input signal is at the same level as the state signal when the fan motor is stopped.

The motor as the object of lock detection is not limited to a motor for rotating a fan. It may be a motor used for other purpose, such as a motor used for an actuator, or it may be a brushless motor such as a reluctance motor or a stepping motor.

Though description has been made with reference to an image forming apparatus, the lock detecting circuit is applicable to detection of locked state of a fan provided in an apparatus other than the image forming apparatus.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

According to the present invention, when a plurality of motors are driven by one CPU, it is possible to detect that any of the motors is locked and, in addition, to identify the locked motor. Therefore, it is possible to stop only the locked motor and to present information related to the locked motor.

### DESCRIPTION OF THE REFERENCE SIGNS

200, 300 lock detecting circuit
202, 204 CPU
210 first fan motor
212 second fan motor
220 first switch
222 second switch
230, 232 logical sum operation element
240 first gate
242 second gate
250 first pull-up resistor
252 second pull-up resistor
254 first pull-down resistor
256 second pull-down resistor
260 ROM
262 RAM
264 timer

1. A lock detecting circuit for a plurality of motors, comprising:
a control unit;
a power supply unit, responsive to a control signal corresponding to each of said plurality of motors, output from said control unit, for supplying electric power to said motor corresponding to the control signal;
a plurality of gate units respectively corresponding to said plurality of motors, each of which selectively outputting, in accordance with a level of each of said plurality of control signals, a state signal indicating state of rotation of the motor input from said motor corresponding to the control signal; and
a logical operation unit receiving gate output signals output from said plurality of gate units, and selectively outputting a signal of one of different levels depending on whether a signal of a first level indicating that rotation of said motor is stopped is included among said gate output signals; wherein
if said control signal is a signal of a second level causing said power supply unit to supply electric power to said motor corresponding to the control signal, said gate unit outputs directly or after inversion said state signal input to said gate unit, as said gate output signal;
if said control signal is a signal of a third level not causing said power supply unit to supply electric power to said motor corresponding to the control signal, said gate output signal becomes a signal of a fourth level obtained by inverting said first level; and
in response to detecting that the output signal from said logical operation unit is a signal of a fifth level output when said gate output signals received by said logical operation unit include said signal of said first level, said control unit changes levels of said plurality of control signals such that said plurality of control signals include said signal of said third level, and thereby identifies a locked motor among said plurality of motors.

2. The lock detecting circuit according to claim 1, wherein
said first level is a high level; and
said logical operation unit is a logical sum operation unit.

3. The lock detecting circuit according to claim 1, wherein
said first level is a low level; and
said logical operation unit is a NAND operation unit.

4. The lock detecting circuit according to claim 1, wherein
in response to detecting that the output signal from said logical operation unit is said signal of said fifth level, said control unit changes the levels of said plurality of control signals such that one of said plurality of control signals is said signal of said second level and the control signals other than the control signal of said second level are the signals of said third level, and in this state, determines whether or not the output signal from said logical operation unit is said signal of said fifth level.

5. The lock detecting circuit according to claim 1, wherein
in response to detecting that the output signal from said logical operation unit is said signal of said fifth level, said control unit changes the levels of said plurality of control signals such that one of said plurality of control signals is said signal of said third level and the control signals other than the control signal of said third level are the signals of said second level, and in this state, determines whether or not the output signal from said logical operation unit is said signal of said fifth level.

6. A method of controlling a lock detecting circuit for a plurality of motors, including:
a control unit;
a power supply unit, responsive to a control signal corresponding to each of said plurality of motors, output from said control unit, for supplying electric power to said motor corresponding to the control signal;
a plurality of gate units respectively corresponding to said plurality of motors, each of which selectively outputting, in accordance with a level of each of said plurality of control signals, a state signal indicating state of rotation of the motor input from said motor corresponding to the control signal; and
a logical operation unit receiving gate output signals output from said plurality of gate units, and selectively outputting a signal of one of different levels depending on whether a signal of a first level indicating that rotation of said motor is stopped is included among said gate output signals; wherein
if said control signal is a signal of a second level causing said power supply unit to supply electric power to said motor corresponding to the control signal, said gate unit outputs directly or after inversion said state signal input to said gate unit, as said gate output signal;
if said control signal is a signal of a third level not causing said power supply unit to supply electric power to said motor corresponding to the control signal, said gate output signal becomes a signal of a fourth level obtained by inverting said first level;
said method comprising:
a determining step of causing said control unit to determine whether or not the output signal from said logical operation unit is a signal of a fifth level output when said gate output signals received by said logical operation unit include said signal of said first level;
a step of causing, in response to a determination at the determining step that the output signal from said logical operation unit is said signal of said fifth level, said control unit to change levels of said plurality of control signals such that said plurality of control signals include said signal of said third level; and
a step of causing, with the levels of said plurality of control signals changed, said control unit to determine whether or not the output signal from said logical operation unit is said signal of said fifth level.
